(19) United States
(12) Patent Application Publication
(10) Pub. No.: US 2021/0081066 A1
(43) Pub. Date: Mar. 18, 2021

(54) TOUCH MODULE

(71) Applicant: Primax Electronics Ltd., Taipei (TW)

(72) Inventor: Yu-Zeng Yang, Taipei (TW)

(21) Appl. No.: 16/696,868

(22) Filed: Nov. 26, 2019

(30) Foreign Application Priority Data
Sep. 12, 2019 (TW) 108133057

(51) Int. Cl. G06F 3/041; G06F 3/044; G09G 5/00

(52) U.S. Cl. CPC G06F 3/0412; G09G 5/006; G06F 3/044; G06F 3/0418

(57) ABSTRACT

A touch module includes a light guide plate, a light source module, a conductive circuit and a protective cover. The light source module emits a light beam. The light guide plate includes plural luminous patterns. The conductive circuit is disposed on a top surface of the light guide plate. When a touch action of a finger is detected by the conductive circuit, a touch signal is generated. The protective cover is placed over the light guide plate and the conductive circuit to cover and protect the conductive circuit, and touchable by the finger. When the light beam is projected to the plural luminous patterns, the plural luminous patterns are shown on the protective cover. When the light beam is not generated, the plural luminous patterns are not shown on the protective cover.

### FIELD OF THE INVENTION

The present invention relates to an input device, and more particularly to a touch module that is installed on a computer.

### BACKGROUND OF THE INVENTION

The widely-used peripheral input device of a computer system includes for example a mouse device, a keyboard device, a trackball device, or the like. With the progress of the times, a touch module is introduced into the market. By directly using the user's fingers to operate the touch module, the computer system can be correspondingly controlled. The applications of the touch module are very extensive. In the early stage, a notebook computer is equipped with a touch module. By operating the touch mouse, the movement of a cursor may be controlled or a corresponding icon of a user interface may be clicked without the need of using a mouse to operate the notebook computer. In accordance with an advantage of the touch module, the touch module can be intuitively operated by the user and thus various commands can be correspondingly executed.

FIG. 1 schematically illustrates a conventional notebook computer with a touch module. The touch module 1 is installed on a computer casing 101 of a notebook computer 10. Moreover, the touch module 1 is partially exposed outside the computer casing 101. When the touch module 1 is touched by the user's finger, the notebook computer 10 is correspondingly controlled. For example, when the user's finger is placed on the touch module 1 and moved on the touch module 1, a cursor 103 shown on a display screen 102 of the notebook computer 10 is correspondingly moved. Alternatively, the user may press down the touch module 1 to execute a button function of the notebook computer 10. In other words, the touch module 1 can be used to replace the mouse. Since it is not necessary to additionally carry and install the mouse, the use of the touch module is more convenient.

With increasing development of science and technology, a multi-function touch module has been introduced into the market to provide more functions. The touch module comprises an illumination module to emit a light beam. In a case that the illumination module is enabled, the light beam is transmitted through the touch module, and thus a preset pattern of the touch module is visible. Meanwhile, the touch module is in a first input module. For example, a numeric keyboard pattern is shown on the touch module. Under this circumstance, the touch module can be employed to input numbers. Whereas, in a case that the illumination module is disabled, the preset pattern is invisible, and thus the touch module is operated in a second input mode. For example, the touch module has the conventional function of moving the cursor.

That is, the user may realize the current input mode of the touch module by judging whether the preset pattern is visible or not, and performs an associated operation according to the input mode. For example, if the illumination module is disabled, the whole outward appearance of the touch module looks black, and the input mode is a preset mouse cursor control mode. Under this circumstance, the user may perform a mouse-moving action or a clicking action by operating the whole black touch module. Whereas, if the illumination module is enabled, a luminous numeric keyboard is shown on the touch module, and the input mode is a preset numeric keyboard control mode. Under this circumstance, the user may input characters and symbols via the touch module according to the visible numeric keyboard pattern.

The inner structure of a multi-function touch module will be described as follows. FIG. 2 is a schematic cross-sectional side view illustrating a conventional multi-function touch module. As shown in FIG. 2, the conventional multi-function touch module 2 comprises a circuit board 21, plural light-emitting elements 22, a light guide plate 23 and a protective cover 24. For succinctness, only one light-emitting element 22 is shown in the drawing. The circuit board 21 comprises a first conductive circuit 211 and a second conductive circuit 212. The light-emitting element 22 is installed on an edge of the circuit board 21 and electrically connected with the first conductive circuit 211. By acquiring electric power from the circuit board 21, the light-emitting element 22 is driven to emit a light beam B1. The light guide plate 23 is installed on the circuit board 21. The plural light-emitting elements 22 are located beside a lateral edge of the light guide plate 23. Due to this arrangement, the light beams B1 emitted by the plural light-emitting elements 22 can be projected into the light guide plate 23. Moreover, the light guide plate 23 comprises plural light-guiding dots 231. When the light beams B1 are projected on the light-guiding dots 231, the travelling directions of the light beams B1 are changed and the light beams B1 are projected upwardly. The protective cover 24 is placed over the light guide plate 23 to cover and protect the light guide plate 23. The protective cover 24 comprises plural patterns 241. The plural patterns 241 are printed on the protective cover 24.

The first conductive circuit 211 of the circuit board 21 is located under the protective cover 24. When the user's finger touching on the protective cover 24 is detected by the first conductive circuit 211, a corresponding touch signal is generated. Due to the above structure, the conventional multi-function touch module 2 can provide different input functions in different statuses. The first conductive circuit 211 and the second conductive circuit 212 are made of metallic material and formed on the circuit board 21.

However, the conventional multi-function touch module 2 still has some drawbacks. For detecting the touch position of the user's finger, the size of the circuit board 21 has to match the size of the whole protective cover 24. Since the size and thickness of the touch module 2 are too large, it is difficult to miniaturizing the touch module.

Therefore, there is a need of providing a touch module with slim appearance.

### SUMMARY OF THE INVENTION

An object of the present invention provides a touch module with slim appearance.

In accordance with an aspect of the present invention, a touch module is provided. The touch module generates a touch signal in response to a touch action of a finger. The touch module includes a light guide plate, a light source module, a conductive circuit and a protective cover. The light guide plate includes plural luminous patterns. The light source module is located beside a lateral edge of the light guide plate. The light source module emits a light beam and projects the light beam to the light guide plate. The conductive circuit is disposed on a top surface of the light guide plate. When the touch action of the finger is detected by the conductive circuit, the touch signal is generated. The protective cover is placed over the light guide plate and the conductive circuit to cover and protect the conductive circuit, and touchable by the finger. When the light beam is projected to the plural luminous patterns, the plural luminous patterns are shown on the protective cover. When the light beam is not generated, the plural luminous patterns are not shown on the protective cover.

In accordance with another aspect of the present invention, a touch module is provided. The touch module generates a touch signal in response to a touch action of a finger. The touch module includes a light guide plate, a light source module, a first conductive circuit, a second conductive circuit and a protective cover. The light guide plate includes plural luminous patterns. The light source module is located beside a lateral edge of the light guide plate. The light source module emits a light beam and projects the light beam to the light guide plate. The first conductive circuit is disposed on a top surface of the light guide plate. The second conductive circuit is disposed on a bottom surface of the light guide plate. When the touch action of the finger is detected by the first conductive circuit and the second conductive circuit, the touch signal is generated. The protective cover is placed over the light guide plate and the first conductive circuit to cover and protect the first conductive circuit, and touchable by the finger. When the light beam is projected to the plural luminous patterns, the plural luminous patterns are shown on the protective cover. When the light beam is not generated, the plural luminous patterns are not shown on the protective cover.

From the above descriptions, the conductive circuit of the touch module for detecting the user's finger is disposed on the light guide plate. Due to the material property of the conductive circuit, the touch module has the light and slim structure. Consequently, the conductive circuit does not largely increase the thickness of the light guide plate. Moreover, since the circuit board of the touch module does not need to detect the operation of the user's finger, the size of the circuit board is reduced. That is, if the circuit board is able to support the plural light-emitting elements, the size of the circuit board is enough. Since the touch module has the slim appearance, the drawbacks of the conventional technologies are overcome.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional notebook computer with a touch module;

FIG. 2 is a schematic cross-sectional side view illustrating a conventional multi-function touch module;

FIG. 3 is a schematic cross-sectional side view illustrating the structure of a touch module according to a first embodiment of the present invention; and

FIG. 4 is a schematic cross-sectional side view illustrating the structure of a touch module according to a second embodiment of the present invention.

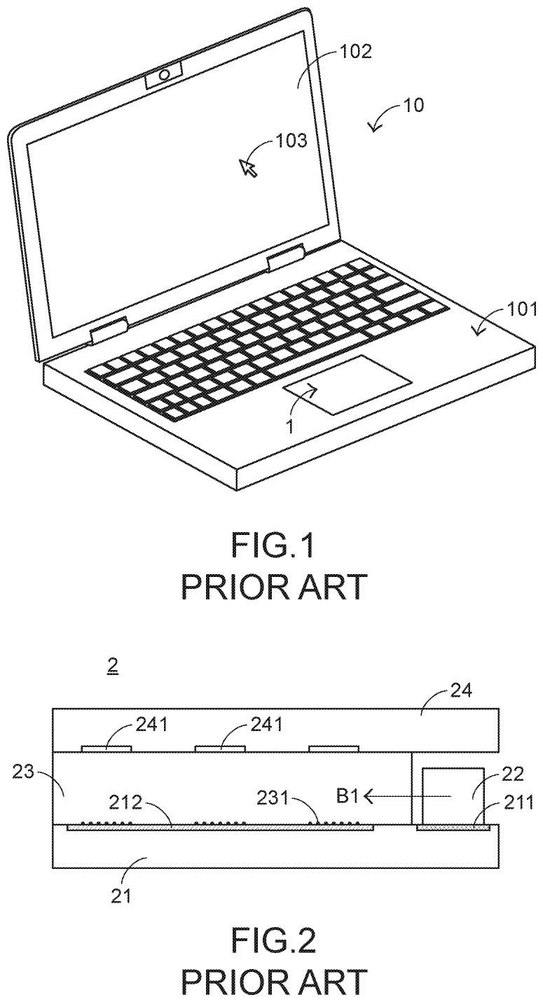

### DETAILED DESCRIPTION OF THE PREFERRED EMBODIMENT

The present invention provides a touch module in order to overcome the drawbacks of the conventional technologies. The embodiments of present invention will be described more specifically with reference to the following drawings. For well understanding the present invention, the elements shown in the drawings are not in scale with the elements of the practical product. In the following embodiments and drawings, the elements irrelevant to the concepts of the present invention or the elements well known to those skilled in the art are omitted. It is noted that numerous modifications and alterations may be made while retaining the teachings of the invention.

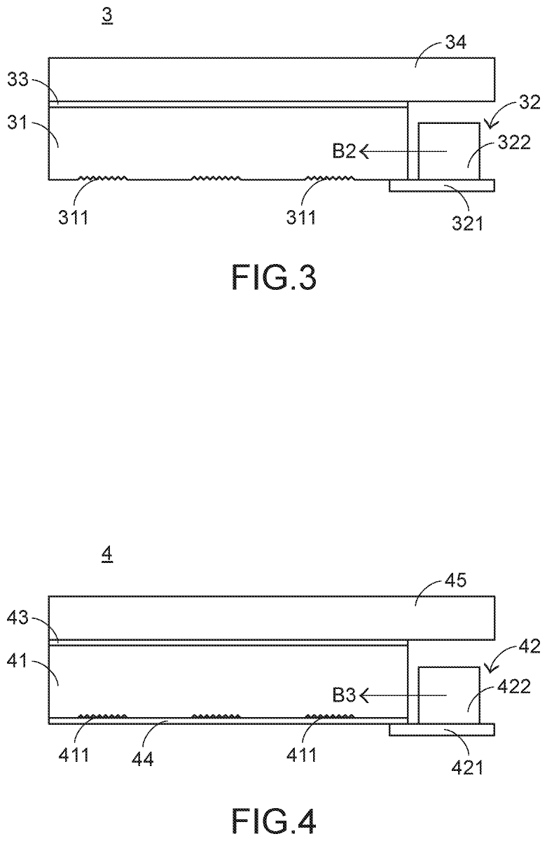

FIG. 3 is a schematic cross-sectional side view illustrating the structure of a touch module according to a first embodiment of the present invention. When the touch module 3 is touched by the user's finger, a corresponding touch signal is generated. The touch module 3 comprises a light guide plate 31, a light source module 32, a conductive circuit 33 and a protective cover 34. The light guide plate 31 comprises plural luminous patterns 311. The light source module 32 is located beside a lateral edge of the light guide plate 31. The light source module 32 emits a light beam B2 and projecting the light beam B2 into the light guide plate 31. The conductive circuit 33 is disposed on a top surface of the light guide plate 31. By detecting the touch position of the user's finger, the conductive circuit 33 generates a corresponding touch signal. The protective cover 34 is located over the light guide plate 31 and the conductive circuit 33 to cover and protect the conductive circuit 33. When the light beam B2 is projected to the plural luminous patterns 311, the plural luminous patterns 311 are shown on the protective cover 34. In case that the light beam B2 is not generated, the plural luminous patterns 311 are not shown on the protective cover 34.

In an embodiment, the plural luminous patterns 311 are halftone dots or light-guiding microstructures that are disposed on a bottom surface of the light guide plate 31. The protective cover 34 is made of translucent material. Moreover, the protective cover 34 has a predetermined opacity. When the light beam B2 is transferred through the plural luminous patterns 311 and projected to the protective cover 34, the plural luminous patterns 311 are shown on the protective cover 34. When the light beam B2 is not projected to the protective cover 34, the plural luminous patterns 311 are not shown on the protective cover 34 because of the predetermined opacity of the protective cover 34.

The light source module 32 comprises a circuit board 321 and plural light-emitting elements 322. For succinctness, only one light-emitting element 322 is shown on the drawing. The circuit board 321 is located beside the lateral edge of the light guide plate 31. The circuit board 321 can provide electric power to the plural light-emitting elements 322. The plural light-emitting elements 322 are installed on the circuit board 321. By acquiring the electric power from the circuit board 321, the light-emitting elements 322 emit light beams B2. In an embodiment, the light-emitting elements 322 are side-view light emitting diodes, and the circuit board 321 is a printed circuit board (PCB) or a flexible printed circuit (FPC).

The light guide plate 31 is made of glass material, polycarbonate (PC) or polymethyl methacrylate (PMMA). Moreover, the conductive circuit 33 is formed by performing a photolithography process or a laser process to etch the light guide plate 31. Moreover, the conductive circuit 33 is electrically connected to an external driving circuit (not shown) through other conductive circuits. In an embodiment, the conductive circuit 33 is made of indium tin oxide (ITO), and the conductive circuit 33 and the light guide plate 31 are collaboratively formed as a self-capacitance touch panel. Since the indium tin oxide is a transparent material, the light beams B2 are not blocked by the conductive circuit 33, the luminous efficacy of the touch module 3 is not adversely affected. The detailed structure and the operating principle of the self-capacitance touch panel are well known to those skilled in the art, and are not redundantly described herein.

The operations of the touch module 3 will be described herein. When the light source module 32 is not driven and the light beams B2 are not generated, the touch module 3 is in a first input mode. Meanwhile, the plural luminous patterns 311 are not shown on the protective cover 34 because of the predetermined opacity of the protective cover 34. When the light source module 32 is driven to emit the light beams B2, the touch module 3 is in a second input mode. After the light beams B2 are projected into the light guide plate 31 and transferred through the plural luminous patterns 311, the travelling directions of the light beams B2 are changed and the light beams B2 are projected upwardly to the protective cover 34. Consequently, the plural luminous patterns 311 are shown on the protective cover 34. The process of switching the operation mode of the touch module 3 may be implemented through an external microprocessor or control chip. The principle of using the external microprocessor or control chip to switch the operation mode of the touch module is well known to those skilled in the art, and is not redundantly described herein.

As shown in FIG. 3, the conductive circuit 33 of the touch module 3 for detecting the user's finger is disposed on the light guide plate 31. Due to the material property of the conductive circuit 33, the touch module 3 has the light and slim structure. Consequently, the conductive circuit 33 does not largely increase the thickness of the light guide plate 31. Moreover, since the circuit board 321 of the touch module 3 does not need to detect the operation of the user's finger, the size of the circuit board 321 is reduced. That is, if the circuit board 321 is able to support the plural light-emitting elements 322, the size of the circuit board 321 is enough. Since the touch module 3 has the slim appearance, the drawbacks of the conventional technologies are overcome.

The present invention further provides a second embodiment, which is distinguished from the first embodiment. FIG. 4 is a schematic cross-sectional side view illustrating the structure of a touch module according to a second embodiment of the present invention. The touch module 4 comprises a light guide plate 41, a light source module 42, a first conductive circuit 43, a second conductive circuit 44 and a protective cover 45. The light guide plate 41 comprises plural luminous patterns 411. The light source module 42 comprises a circuit board 421 and plural light-emitting elements 422. The plural light-emitting elements 422 emit light beams B3. The structures and functions of the components of the touch module 4 which are identical to those of the first embodiment are not redundantly described herein. In comparison with the first embodiment, the touch module 4 of this embodiment further comprises the second conductive circuit 44.

As shown in FIG. 4, the first conductive circuit 43 is disposed on a top surface of the light guide plate 41. The second conductive circuit 44 is disposed on a bottom surface of the light guide plate 41. The touch position of the user's finger is detected by the second conductive circuit 44 and the first conductive circuit 43 collaboratively, and thus the corresponding touch signal is generated. In this embodiment, the first conductive circuit 43, the second conductive circuit 44 and the light guide plate 41 are collaboratively formed as a mutual-capacitance touch panel. The first conductive circuit 43 and the second conductive circuit 44 are made of indium tin oxide (ITO). The processes of forming the first conductive circuit 43 and the second conductive circuit 44 are similar to the process of forming the conductive circuit 33 of the first embodiment, and are not redundantly described herein.

As shown in FIG. 4, the first conductive circuit 43 and the second conductive circuit 44 of the touch module 4 for detecting the user's finger are disposed on the light guide plate 41. Due to the material properties of the first conductive circuit 43 and the second conductive circuit 44, the touch module 4 has the light and slim structure. Consequently, the first conductive circuit 43 and the second conductive circuit 44 do not largely increase the thickness of the light guide plate 41. Similarly, since the circuit board 421 of the touch module 4 does not need to detect the operation of the user's finger, the size of the circuit board 421 is reduced. That is, if the circuit board 421 is able to support the plural light-emitting elements 422, the size of the circuit board 421 is enough. Since the touch module 4 has the slim appearance, the drawbacks of the conventional technologies are overcome.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A touch module generating a touch signal in response to a touch action of a finger, the touch module comprising:
a light guide plate comprising plural luminous patterns;
a light source module located beside a lateral edge of the light guide plate, wherein the light source module emits a light beam and projects the light beam to the light guide plate;
a conductive circuit disposed on a top surface of the light guide plate, wherein when the touch action of the finger is detected by the conductive circuit, the touch signal is generated; and
a protective cover placed over the light guide plate and the conductive circuit to cover and protect the conductive circuit, and touchable by the finger, wherein when the light beam is projected to the plural luminous patterns, the plural luminous patterns are shown on the protective cover, wherein when the light beam is not generated, the plural luminous patterns are not shown on the protective cover.

2. The touch module according to claim 1, wherein the light source module comprises:
a circuit board located beside the lateral edge of the light guide plate, and providing electric power; and
a light-emitting element installed on the circuit board, wherein the light-emitting element emits the light beam in response to the electric power.

3. The touch module according to claim 1, wherein the conductive circuit and the light guide plate are collaboratively formed as a self-capacitance touch panel, and the conductive circuit is made of indium tin oxide.

4. The touch module according to claim 1, wherein the plural luminous patterns are halftone dots or light-guiding microstructures that are disposed on a bottom surface of the light guide plate.

5. The touch module according to claim 1, wherein the protective cover is made of translucent material, and the protective cover has a predetermined opacity, wherein when the light beam is projected to the protective cover through the plural luminous patterns, the plural luminous patterns are shown on the protective cover, wherein when the light beam is not projected to the protective cover, the plural luminous patterns are not shown on the protective cover because of the predetermined opacity.

6. A touch module generating a touch signal in response to a touch action of a finger, the touch module comprising:
a light guide plate comprising plural luminous patterns;
a light source module located beside a lateral edge of the light guide plate, wherein the light source module emits a light beam and projects the light beam to the light guide plate;
a first conductive circuit disposed on a top surface of the light guide plate;
a second conductive circuit disposed on a bottom surface of the light guide plate, wherein when the touch action of the finger is detected by the first conductive circuit and the second conductive circuit, the touch signal is generated; and
a protective cover placed over the light guide plate and the first conductive circuit to cover and protect the first conductive circuit, and touchable by the finger, wherein when the light beam is projected to the plural luminous patterns, the plural luminous patterns are shown on the protective cover, wherein when the light beam is not generated, the plural luminous patterns are not shown on the protective cover.

7. The touch module according to claim 6, wherein the light source module comprises:
a circuit board located beside the lateral edge of the light guide plate, and providing electric power; and
a light-emitting element installed on the circuit board, wherein the light-emitting element emits the light beam in response to the electric power.

8. The touch module according to claim 6, wherein the first conductive circuit, the second conductive circuit and the light guide plate are collaboratively formed as a mutual-capacitance touch panel, and the first conductive circuit and the second conductive circuit are made of indium tin oxide.

9. The touch module according to claim 6, wherein the plural luminous patterns are halftone dots or light-guiding microstructures that are disposed on a bottom surface of the light guide plate.

10. The touch module according to claim 6, wherein the protective cover is made of translucent material, and the protective cover has a predetermined opacity, wherein when the light beam is projected to the protective cover through the plural luminous patterns, the plural luminous patterns are shown on the protective cover, wherein when the light beam is not projected to the protective cover, the plural luminous patterns are not shown on the protective cover because of the predetermined opacity.
